(19) United States
(12) Patent Application Publication
(10) Pub. No.: US 2006/0266537 A1
(43) Pub. Date: Nov. 30, 2006

(54) Rotary impact tool having a ski-jump clutch mechanism

(76) Inventor: Osamu Izumisawa, Tokyo (JP)

Correspondence Address: SENNIGER POWERS, ONE METROPOLITAN SQUARE, 16TH FLOOR, ST LOUIS, MO, 63102, US

(21) Appl. No.: 11/139,201

(22) Filed: May 27, 2005

(51) Int. Cl. B23Q 5/00

(52) U.S. Cl. 173/176

(57) ABSTRACT

A clutch mechanism for a rotary impact tool comprises a cam ball and a cam follower. The cam follower includes a raceway for allowing the cam ball to travel along a surface of the cam follower. The raceway includes a crest having a ramp with a concave slope for inhibiting the cam ball from passing over the crest when the tool is not loaded while allowing the cam ball to travel over the crest when the tool is loaded to thereby push the cam follower axially forward to cause a hammer to impact an output shaft.

### BACKGROUND OF THE INVENTION

This invention relates generally to power driven hand tools and more specifically to a rotary impact wrench having an intermittent drive clutch mechanism.

Rotary impact wrenches of the type to which the present invention is related have employed different mechanisms for applying an impact force to an output shaft for turning a fastener element, such as a nut. These impacts develop relatively instantaneously high torque in the output shaft for tightening (or loosening) the fastener elements. Most rotary impact mechanisms include an output shaft including an anvil periodically impacted by hammers. The hammers are typically mounted for motion with respect to the anvil. A clutch mechanism is provided to periodically move the hammers between a position in which the hammers will strike the anvil, and a position in which they are clear of the anvil. When clear of the anvil, the hammers gain speed, and hence momentum, for the next impact with the anvil.

There are presently several types of impact mechanisms. One type of rotary impact wrench, such as shown in U.S. Pat. No. 3,661,217, uses a “swinging weight” mechanism in which hammer dogs are mounted for pivoting about axes parallel to, but spaced from the central axis of the output shaft. A lobe on the output shaft forms the anvil to be struck by the hammer dogs. The hammer dogs, which also rotate around the output shaft, periodically strike the anvil to deliver an impact to the output shaft. In another type of impact mechanism, a spring biases each hammer toward a position in which the hammer is in engagement with the anvil. However, cam balls riding in raceways in a motor driven shaft periodically force the hammers out of engagement with the anvil.

A third type of rotary impact wrench, such as shown in U.S. Pat. No. 2,881,884 and to which the present invention is particularly related, employs a “ski-jump” mechanism in which the output shaft is mounted for free rotation about its longitudinal axis in a tubular cage rotated by a motor about its longitudinal axis. The output shaft has two anvils projecting radially outward in opposite directions. Hammers mounted for rotation with the cage are spring biased axially away from the anvils, but connected to a cam follower for axial motion. A cam ball rotating with the cage periodically engages the cam follower, throwing the hammers forward into registration with the anvils so that they strike the anvils to deliver an impact force for turning the output shaft with a relatively instantaneous high torque.

Some of the prior “ski-jump” clutch mechanisms, such as that disclosed in U.S. Pat. No. 5,199,505, have a cam follower with a surface along which the cam ball travels. The cam follower includes a generally triangular shaped finger projecting radially outward. The sides of the finger serve as ramps so that the cam ball can travel over the finger.

When being used to tighten fastener elements, the output shaft is initially loaded with only a small torque, such as caused by the inertia of the fastener element being turned and the frictional interengagement between the turning and stationary fastener elements. The initial load is insufficient to overcome the force of a spring pushing the hammer pins and cam follower rearwardly. Thus, the cam ball remains engaged with one side of the finger, pushing it around the central longitudinal axis so that the cam follower and output shaft rotate.

As the torque experienced by the output shaft increases, the resistance to rotation of the output shaft and cam follower increases and the axial component of the force exerted by the cam ball on the finger increases until the cam ball is able to drive the cam follower forward far enough to pass over the finger and down the opposite side. Thereafter, the cage and cam ball rotate at high speed until they catch up with the cam follower finger. The cam ball passes over the cam follower finger rapidly, causing the hammer pins to be thrown forward so that the hammer pins are brought into registration with the anvils of the output shaft. Because the cam ball quickly passes the finger, the hammer pins quickly move out of registration with the anvils. Therefore, the hammer pins deliver a quick, sharp impact to the anvils to tighten the fastener element an incremental amount, and then release to regain momentum for the next impact.

However, in the prior designs, the ramps of the fingers are insufficiently shaped to prevent the cam ball from being pushed over the finger and thereby forcing the hammer pins into contact with the anvils when the shaft is minimally loaded or not loaded. As a result, the hammers, anvils, and other components of the tool are unnecessarily subject to stresses that wear on tools components. Moreover, the efficiency of the tool is diminished when hammer prematurely engages the anvil because the rotational speed of the output shaft is reduced.

### SUMMARY OF THE INVENTION

In one aspect, the present invention is directed generally to a rotary impact tool comprising a housing and an output shaft for tightening and loosening fastener elements. The output shaft includes an anvil projecting radially outwardly from the output shaft. A motor is mounted in the housing for driving the output shaft. At least one hammer is adapted to be driven by the motor. A clutch mechanism can move the hammer to strike the anvil for delivering an impact to the output shaft. The clutch mechanism is connected to the output shaft such that when the output shaft is not loaded the hammer is not positioned to strike the anvil and when the output shaft is loaded the hammer is moved for intermittently striking the anvil. The clutch mechanism includes a cam ball and a cam follower. The cam follower includes a raceway for allowing the cam ball to travel along a surface of the cam follower. The raceway includes a ramp extending to a crest, the ramp being formed to increase resistance to movement of the cam ball as the cam ball nears the crest for inhibiting the cam ball from passing over the crest when the shaft is not loaded while allowing the cam ball to travel over the crest when the shaft is loaded to thereby push the cam follower and hammer axially forward causing the hammer to strike the anvil.

In another aspect, the present invention is directed generally to a clutch mechanism for a rotary impact tool comprising a cam ball and a cam follower. The cam follower includes a raceway for allowing the cam ball to travel along a surface of the cam follower. The raceway includes a ramp extending to a crest, the ramp being formed to increase resistance to movement of the cam ball as the cam ball nears the crest for inhibiting the cam ball from passing over the crest when the tool is not loaded while allowing the cam ball to travel over the crest when the tool is loaded to thereby push the cam follower axially forward to cause a hammer to impact an output shaft.

Other objects and features of the invention will be in part apparent and in part pointed out hereinafter.

### BRIEF DESCRIPTION OF THE DRAWINGS

FIG. 1 is an elevation of a rotary impact tool of the present invention with parts broken away to show the cage and output shaft of the tool;

FIG. 2 is a longitudinal section of the cage showing a clutch mechanism and hammer pins in their retracted position;

FIG. 3 is a longitudinal section of the cage showing the clutch mechanism with the hammer pins in their extended position;

FIG. 4 is a section taken in the plane including line 4-4 of FIG. 2;

FIG. 5 is a section taken in the plane including line 5-5 of FIG. 3;

FIG. 6 is a section taken in the plane including line 6-6 of FIG. 3;

FIG. 7 is a perspective of a cam ball and a cam follower of the clutch mechanism;

FIG. 8 is an end elevation of the cam follower showing a finger of the cam follower;

FIG. 9 is an elevation of the cam follower showing the interior side of the finger;

FIG. 10 is an elevation of the cam follower showing a ramped surface of the finger; and

FIG. 11 is an elevation of the cam follower similar to FIG. 10 but rotated so that the finger is moved forward; and

FIG. 12 is a schematic view of the cage illustrating the position of the cam ball of the cam follower when the hammer pins are in their extended position.

Corresponding reference characters indicate corresponding parts throughout the several views of the drawings.

### DETAILED DESCRIPTION OF THE INVENTION

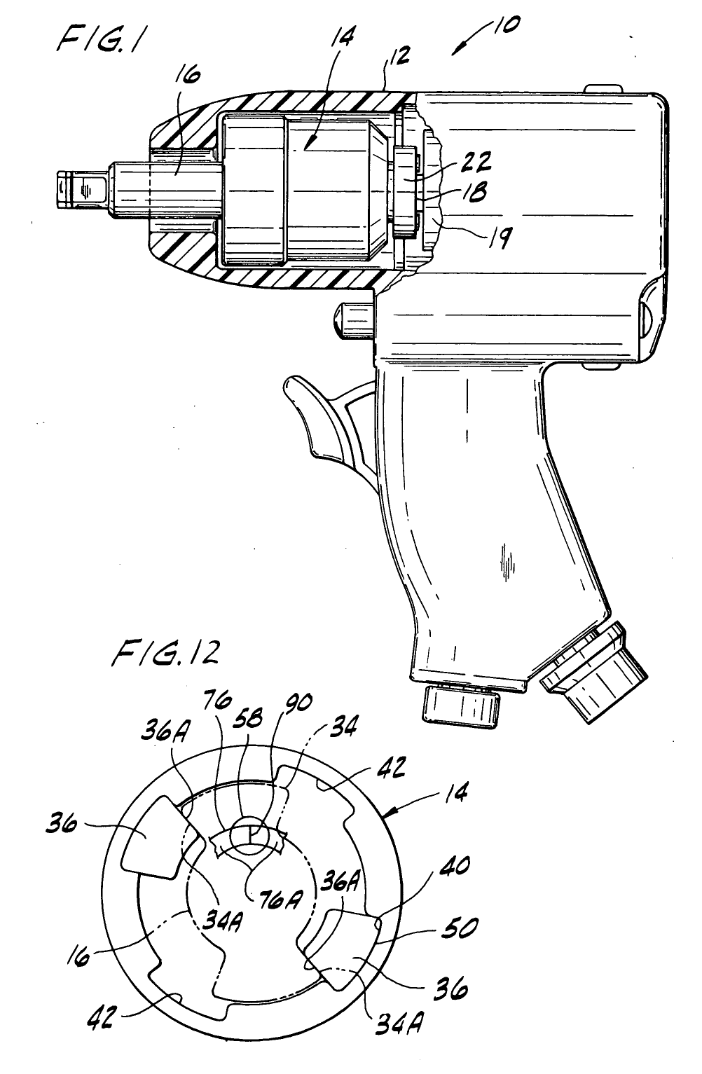

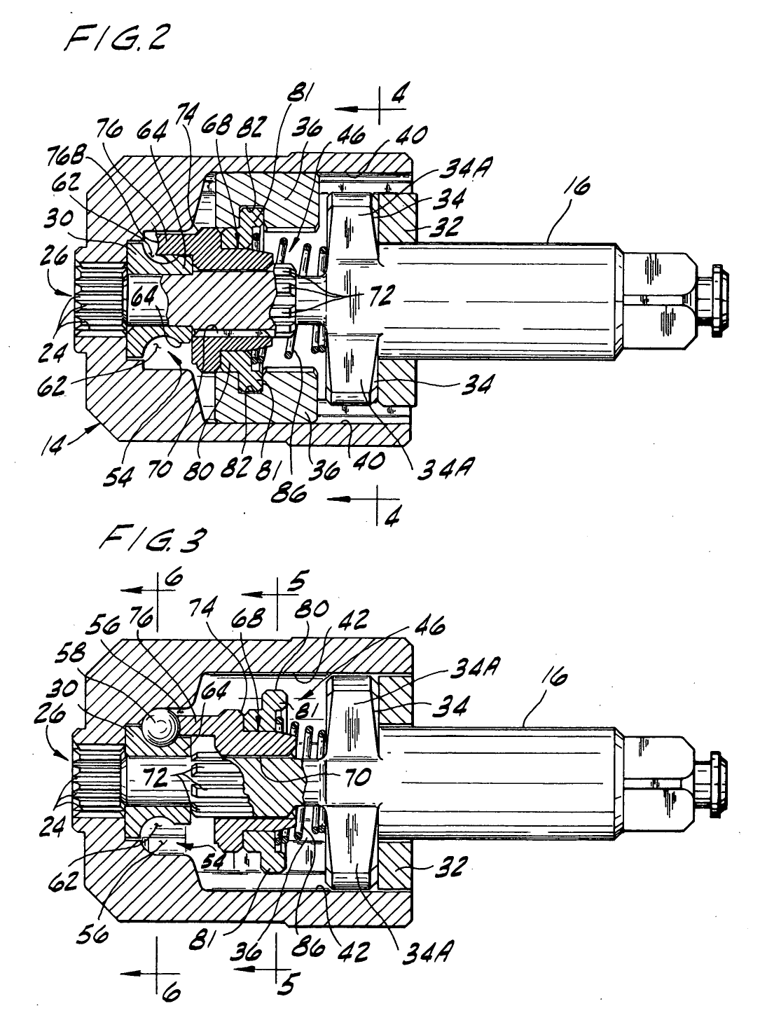

Referring now to the drawings, and in particular to FIG. 1, an air-driven rotary impact wrench constructed according to the principles of the present invention, generally indicated at 10, is shown to comprise a housing 12, a generally tubular cage 14 supported in the housing for rotation relative the housing, and an output shaft 16 which turns a fastener element (not shown), such as a nut or a bolt, for tightening or loosening the fastener element. A motor 19 in the housing 12 is a standard air driven motor of the type commonly used in pneumatic tools, which turns an input shaft 18 supported by shaft bearing 22. It is to be understood that other types of motors could be used and still fall within the scope of the present invention. The input shaft 18 has splines (not shown) at its forward end for connection to corresponding splines 24 (FIG. 2) in an opening 26 in the rearward end of the cage 14 so that the motor 19 rotates the cage about its central longitudinal axis.

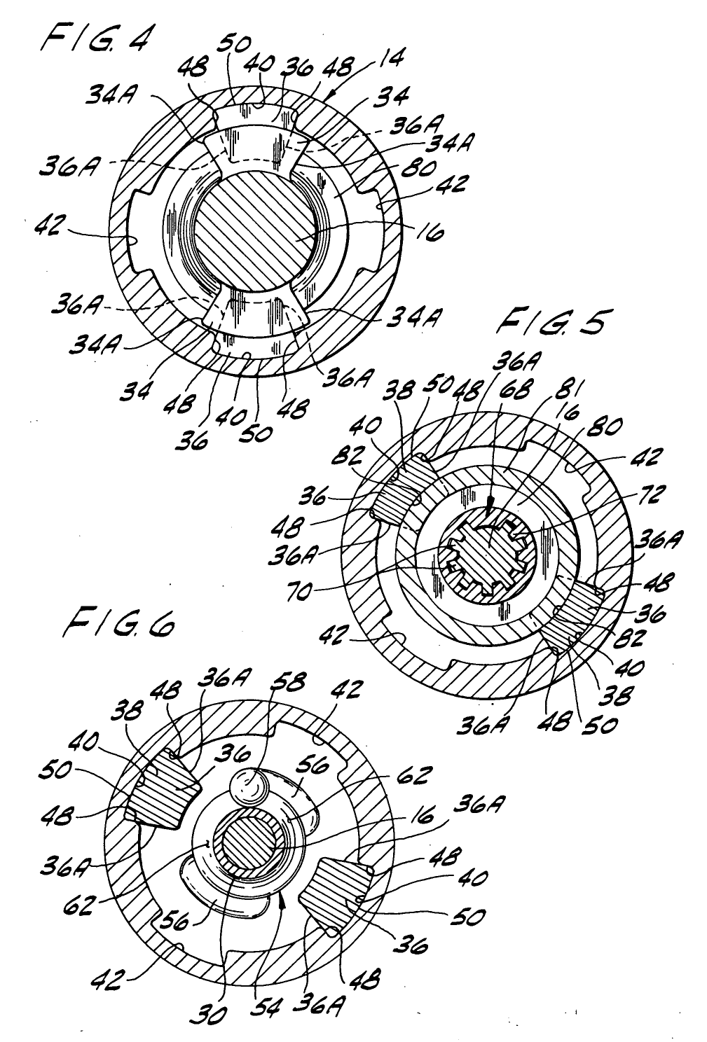

The output shaft 16 is supported generally coaxially with the cage 14 for rotation relative to the cage by an annular member 30 at the rearward end of the cage, and a bushing 32 fitted in the forward end of the cage. Two wedge-shaped anvils 34, which are formed as one piece with the output shaft 16, project outwardly in radially opposite directions from the output shaft. Each anvil 34 has two generally flat impact surfaces 34A which lie in generally radial planes including the central longitudinal axis of the cage 14. A pair of hammer pins 36 made of cold-forged steel are received in two axially extending guide channels 40 formed in an internal wall of the cage 14. The other two channels 42 seen in FIGS. 4-6 are formed solely for ease of machining, and are not sized to receive hammer pins 36. The hammer pins 36 each have two generally flat striking surfaces 36A, for engaging the impact surfaces 34A of the anvils 34, and slightly arcuate radially inner and outer surfaces. As located in the guide channels 40, the striking surfaces 36A of the hammer pins 36 generally lie in radial planes including the central longitudinal axis of the cage. The particular impact and striking surfaces 34A, 36A which engage depends upon the direction of rotation of the cage 14 (i.e., for tightening or loosening the fastener element).

A clutch mechanism indicated generally at 46 intermittently moves the hammer pins 36 axially in the guide channels 40 between a retracted position (FIG. 2), in which the striking surfaces 36A of the hammer pins are spaced rearward of and thus clear of the impact surfaces 34A of the anvils to permit rotation of the cage 14 and the hammer pins relative to the output shaft 16 and anvils 34, and an extended position in which a portion of one of the striking surfaces of each of the hammer pins is in registration with one of the impact surfaces for impact thereagainst. When the hammer pins 36 are extended, further rotation of the cage 14 results in an impact of the striking surfaces 36A of the hammer pins against respective impact surfaces 34A of the anvils for transmitting an impact force to the output shaft 16. The essentially instantaneous application of an impact force to the anvils 34 allows the output shaft 16 to develop higher torque for tightening or loosening fastener elements.

The guide channels 40 are shaped for a close sliding fit with the hammer pins 36 to prevent movement of the pins radially out of the channel or lateral within the channel, and thus substantially restrict the hammer pins to movement longitudinally of the cage 14. As shown in FIGS. 5 and 6, the guide channels 40 and the hammer pins 36 both have generally trapezoidal transverse cross sections, and the portion 38 of each hammer pin 36 received in its respective guide channel has a radially inwardly tapering cross section closely corresponding to the tapered cross section of the channel. Each of the guide channels 40 has generally opposing side walls 48 connected by a slightly arcuate transverse wall 50 at the bottom of the channel. The side walls 48 slope inwardly toward each other from their intersection with the transverse wall 50 and thus hold the wider portion 38 of the respective tapered hammer pin 36 captive in the channel, thereby preventing radially inward movement out of the guide channel 40. Moreover, because the guide channel 40 and portion 38 of the hammer pin 36 received in the channel closely correspond in size and shape, the hammer pin cannot move laterally with respect to the guide channel. The utility of limiting the radial and lateral motion of the hammer pins 36 will be explained more fully below with regard to the operation of the rotary impact wrench 10. However, it will be understood that hammer pins of other shapes (not shown) including cylindrical, may be used without departing from the scope of the present invention. Moreover, the pins may be held in channels that are not as effective in restraining radial and lateral motion of the pins.

The rearward end of the cage 14 has a recess 54 which is generally circular and communicates with the opening 26 in the cage. The recess 54 has radially outwardly flaring extensions which define arcuate outer walls of pockets 56. The inner walls of the pockets 56 are defined by the annular member 30 which is positioned coaxially with the central longitudinal axis of the cage 14. As best seen in FIG. 6, the clutch mechanism 46 includes a cam ball 58 which is received in one of the pockets 56. The radially outer surface of the annular member 30, as may be seen in FIG. 2, is concave and defines a raceway 62 in which the cam ball 58 moves around the central longitudinal axis of the cage. A lip 64 at the forward end of the annular member 30 holds the cam ball 58 against axial movement relative to the cage. The pockets 56 are sufficiently large to permit limited motion of the cam ball 58 in the raceway 62 relative the cage 14. However, upon rotation of the cage 14, engagement of the cam ball 58 with the outer wall of the pocket 56, as shown in FIG. 6, drives the cam ball around the raceway 62 in conjoint motion with the cage.

A tubular cam follower 68 located forwardly of the annular member 30 fits around the output shaft 16 and is connected by internal splines 70 to splines 72 on the output shaft for conjoint rotation with the output shaft. However, the spline connection leaves the cam follower 68 free to move axially relative the output shaft 16. The cam follower 68 includes a radially outwardly projecting flange 74 which is formed with a finger 76 projecting rearwardly into the recess 54 in the cage 14 where it would be free to rotate in the recess about the central longitudinal axis of the cage 14 but for the presence of the cam ball 58.

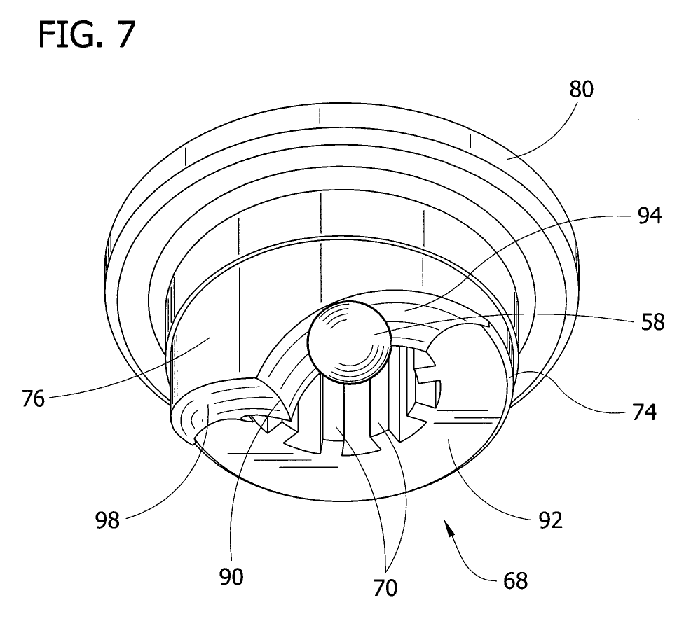

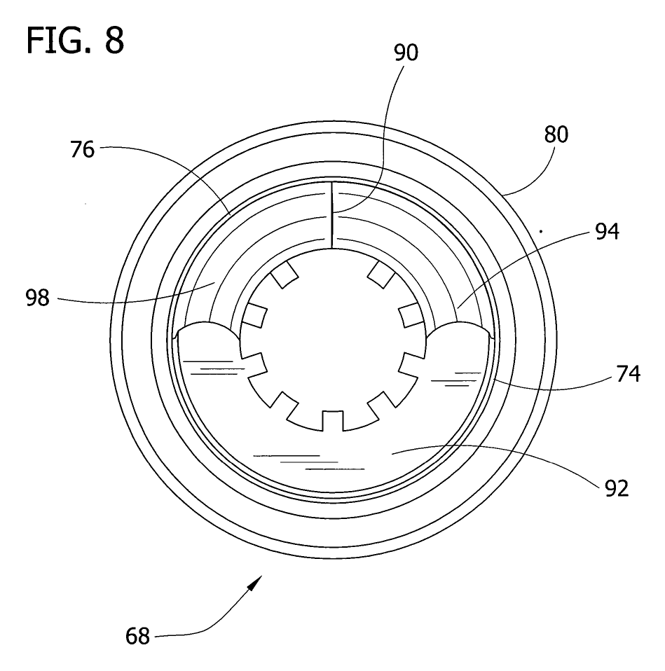

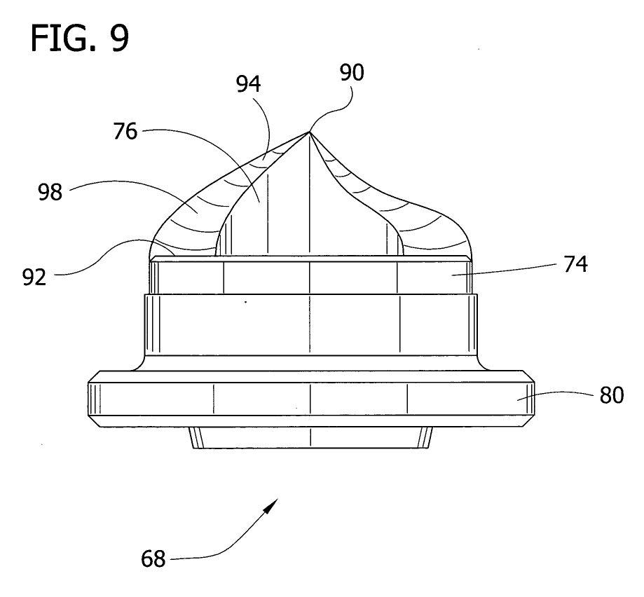

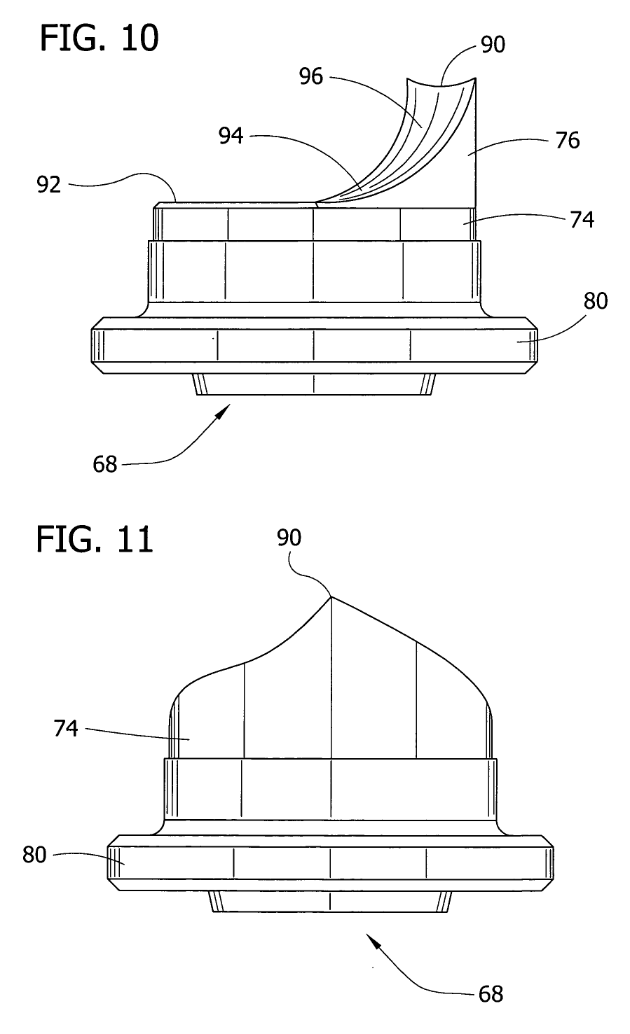

As shown in FIGS. 7-11, the finger 76 is roughly triangular in shape, but bent out of plane so that it follows the circumference of the cam follower flange 74. The cam follower 68 includes a raceway 92 for allowing the cam ball 58 to travel along a surface of the cam follower. The raceway 92 includes a ramp 94 so that the cam ball 58 can pass over the finger 76. The ramp 94 of the finger 76 allows the cam ball 58 to travel up the finger, and a descent portion 98 of the fingers allows the cam ball to travel down the finger. The ramp 94 has a concave shape so that the slope of the ramp increases from the end of the ramp adjacent a flat part of the raceway 92 toward the crest 90. The descent portion 98 has a substantially constant slope from the crest 90 to the flat part of the raceway. The concave slope of the ramp 94 provides increasing resistance to the cam ball 58 as it travels over the finger 76. As illustrated, the concave slope of the ramp 94 is an arc having a constant radius of curvature. In the illustrated configuration, the arc has a radius of about 8 millimeters. It is understood, however, that the arc may have other radii without departing from the scope of this invention. For example, the radius of the arc may be altered to accommodate various sized impact wrenches or desired amounts of resistance to the cam ball 58. Other shapes (e.g., shapes having a nonconstant radius of curvature) may be used in the present invention.

A thrust ring 80 is adapted for axial movement with the cam follower 68. As shown in FIG. 2, the thrust ring 80 has a rim 81 at its periphery which is received in arcuate notches 82 formed in the radially inwardly facing surface of the hammer pins 36. Therefore, it may be seen that the thrust ring 80 links the axial movement of the cam follower 68 and the hammer pins 36 for sliding the hammer pins axially in their respective guide channels 40. A compression spring 86 is coiled around the output shaft 16 and compressed between the rearwardly facing surface of the anvils 34 and the thrust ring 80. The spring 86 biases the thrust ring 80, cam follower 68 and hammer pins 36 rearwardly, away from the anvils 34 of the output shaft 16.

As shown in FIG. 5, the spline connection 70, 72 of the cam follower 68 and the output shaft 16 is keyed so that the cam follower and output shaft are in a predetermined rotational orientation. As may be seen in FIG. 12, the key positions the cam follower finger 76 substantially under one of the anvils 34 of the output shaft 16. The pockets 56 for holding the cam ball 58 are located at positions approximately 90 degrees removed from the guide channels 40. Therefore, engagement of the cam ball 58 with the cam follower finger 76 occurs when the anvils 34 are located away from the guide channels 40 to give the hammer pins 36 room to move axially to bring their striking surfaces 36A into registration with the impact surfaces 34A of the anvils.

In operation, the input shaft 18 of the motor 19 rotates the cage 14. As shown in FIG. 6, the cam ball 58 is engaged in its raceway 62 by the outer wall of the pocket 56 holding the cam ball, and is carried along with the cage 14 in the raceway 62 about the central longitudinal axis of the cage. The output shaft 16, thrust ring 80 and cam follower 68 are not directly connected to the motor 19 for rotation. However, as the ball 58 is carried around the annular member 30 in the raceway 62, it engages the ramp 94 of the cam follower finger 76 and is captured by the concaved slope of the ramp such that the finger is pushed by the ball around the central longitudinal axis to rotate the cam follower 68 conjointly with the cage 14. The output shaft 16 is also rotated because of the spline connection 70, 72 between the cam follower 68 and the output shaft.

When the rotary impact wrench 10 is being used to tighten two fastener elements (not shown), the output shaft 16 is initially loaded with only a small torque resisting its rotation, such as caused by the inertia of the fastener element being turned and the frictional interengagement between the turning and stationary fastener elements. Although the cam ball 58 moves the cam follower 68, thrust ring 80, and hammer pins 36, the axial component of the force exerted by the cam ball on the finger 76 is insufficient to cause the hammer pin 36 to strike the anvils 34. The farther the cam ball 58 is driven up the ramp 94, the greater the slope of the ramp. The axial component of force exerted by the cam ball 58 on the cam follower decreases with the increasing slope of the ramp 94. Thus, a larger resistive torque must be experienced by the output shaft 16 before the cam ball 58 moves over the crest 90 thereby actuating the cam follower 68 to cause the hammer pins 36 to strike the anvil 34. Stated another way, the cam ball 58 experiences increased resistance to movement as it gets closer to the crest 90. The cam ball 58 remains captured by the ramp 94, pushing the finger 76 around the central longitudinal axis such that the cam follower 68 and output shaft 16 rotate with the input shaft 18 of the motor 19 for small increase in resisting torque.

As the fastener element being turned by the output shaft 16 engages the surface (not shown) to which it is being tightened, the torque experienced by the output shaft increases markedly. As the resistance to rotation of the output shaft 16 and cam follower 68 increases, the axial component of the force exerted by the cam ball 58 on the finger 76 increases until the cam ball is able to move up the ramp 94 and drive the cam follower forward far enough to pass over the crest 90 of the finger and down the descent portion 98. The engagement of the cam ball 58 with the ramp 94 is illustrated in FIG. 7. FIG. 12 schematically illustrates the position of the cam ball 58, cam follower finger 76, anvils 34 and hammer pins 36 when the cam ball 58 reaches the crest 90 of the ramp. As the cam ball 58 moves down the descent portion 98 of the ramp 94, the spring 86 moves the thrust ring 80, hammer pins 36 and cam follower 68 rearwardly to substantially the position shown in FIG. 2.

Thereafter, the cage 14 and cam ball 58 rotate at high speed about the central longitudinal axis until they catch up with the cam follower finger 76. The cam ball 58 hits the ramp 94 with at a high momentum, causing the hammer pins 36 to be thrown forwardly with great force against the resisting force of the spring 86 so that the striking surfaces 36A of the hammer pins are brought into registration with the impact surfaces 34A of the anvils 34 of the output shaft 16. Further revolution causes the flat striking surfaces 36A of the hammer pins 36 to impact the flat impact surfaces 34A of the anvils. Because the impact areas engage one another face-to-face over a relatively large area, momentum from the hammer pins and the cage 14 is efficiently transferred to the anvils 34 and output shaft 16. Because the cam ball 58 moves quickly past the crest 90 of the ramp 94, the hammer pins 36 are pushed quickly rearwardly out of registration with the anvils 34. Therefore, the hammer pins 36 deliver a quick, sharp impact to the anvils 34 to tighten the fastener element an incremental amount, and then release to regain momentum for the next impact.

The momentum of the cage 14, which has a significantly greater weight and hence greater momentum than the hammer pins 36, is also efficiently transferred to the anvils 34 because the hammer pins have a close-fitting relationship with the side walls 48 of the channels 40. Thus, rather than moving laterally or radially as a result of the impact with the anvils 34, the hammer pins 36 are held rigid by their close fit with the side walls 48 of the guide channels so that they transfer substantially the full momentum of the cage 14 to the anvils and output shaft 16. The engagement of the hammer pins 36 with the anvils 34 is brief, and a relatively large amount of torque is delivered to the output shaft 16.

The rotary impact wrench 10 of the illustrated embodiment works well at higher air pressures (e.g., above 90 psi up to about 140 psi). At high pressure, the cage 14 rotates so rapidly that the hammer pins 36 impact the anvils 34 before substantial portions of the striking surfaces 36A of the hammer pins move into registration with the impact surfaces 34A of the anvils. Although the area over which the force of the impact is applied to the hammer pins 36 is reduced from the optimum, it is still applied over a flat area of the hammer pin. Moreover, because the hammer pin is closely held in the channel, much of the impact load on the hammer pins 36 is supported by the cage 14. The channels 40 prevent any lateral or radial movement of the hammer pins 36 relative the channels so that stress developed at the notch 82 engaging the rim 81 of the thrust ring 80 is reduced. The provision of a notch on only one side of the hammer pins reduces stress concentration at the notch. Thus, the hammer pins 36 will not merely skip under the anvils 34, which would cause inefficient transfer of momentum and tend to chip the hammer pins. Therefore, the hammer pins 36 have a long operational life even when high pressure is used.

The rotary impact wrench 10 of the present invention provides more reliable and more consistent output than its predecessors. When the rotary impact wrench 10 is loaded with only a small torque resisting its rotation, the cam ball 58 remains captured by the ramp 94 of the cam follower 68 because of the increasing slope of the ramp near the crest 90. As a result, the cam ball 58 consistently pushes the cam follower 67 around the central longitudinal thereby to rotate the output shaft 16. In this first mode of operation (i.e., no or little torque), the output shaft 16 operates with less power but greater speed. The output shaft 16 is maintained constant rotational speed, which is approximately the same speed as the rotational speed of the cage 14. Once the torque experienced by the output shaft increases above a threshold torque, the cam ball is able to drive the cam follower 68 forward far enough to pass over the crest 90 of the finger 76 and down the descent portion 98, which causes the hammer pins 36 to be brought into registration with the anvils 34 of the output shaft 16. Further revolution of the cam ball 58 causes additional impacts to the anvils 34 by the hammer pins 36. In this second mode of operation (i.e, high torque), the output shaft 16 delivers more power but at a lower speed. The rotational speed of the output shaft 16 is this mode is variable and less than that of the rotational speed of the cage 14. Accordingly, the rotary impact wrench 10 of the present invention efficiently tightens and loosens fastening elements.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements. Moreover, the use of “up” and “down” and variations thereof is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A rotary impact tool comprising
a housing,
an output shaft for tightening and loosening fastener elements, said output shaft including an anvil projecting radially outwardly from the output shaft,
a motor mounted in the housing for driving the output shaft,
at least one hammer adapted to be driven by the motor, and
a clutch mechanism for moving the hammer to strike said anvil for delivering an impact to the output shaft, said clutch mechanism being connected to the output shaft such that when the output shaft is not loaded the hammer is not positioned to strike the anvil and when the output shaft is loaded the hammer is moved for intermittently striking the anvil, the clutch mechanism including a cam ball and a cam follower, the cam follower including a raceway for allowing the cam ball to travel along a surface of the cam follower, said raceway including a ramp extending to a crest, the ramp being formed to increase resistance to movement of the cam ball as the cam ball nears the crest for inhibiting the cam ball from passing over the crest when the shaft is not loaded while allowing the cam ball to travel over the crest when the shaft is loaded to thereby push the cam follower and hammer axially forward causing the hammer to strike the anvil.

2. The rotary impact tool as set forth in claim 1 wherein the ramp has a slope that increases toward the crest.

3. The rotary impact tool as set forth in claim 2 wherein the ramp extends generally along an arc having a constant radius of curvature.

4. The rotary impact tool as set forth in claim 3 wherein the radius of curvature of the ramp is about 8 millimeters.

5. The rotary impact tool as set forth in claim 1 wherein the raceway further comprises a descent portion extending from the crest on an opposite side of the crest from the ramp.

6. The rotary impact tool as set forth in claim 5 wherein the descent portion of the raceway has a shape that is different than the ramp of the raceway.

7. The rotary impact tool as set forth in claim 6 wherein the descent portion has a substantially constant slope.

8. The rotary impact tool as set forth in claim 1 further comprising a thrust ring connected to the hammer, said thrust ring being adapted for axial movement with the cam follower to axially move the hammer into and out of contact with the anvil.

9. A clutch mechanism for a rotary impact tool, said clutch mechanism comprising a cam ball and a cam follower, the cam follower including a raceway for allowing the cam ball to travel along a surface of the cam follower, said raceway including a ramp extending to a crest, the ramp being formed to increase resistance to movement of the cam ball as the cam ball nears the crest for inhibiting the cam ball from passing over the crest when the tool is not loaded while allowing the cam ball to travel over the crest when the tool is loaded to thereby push the cam follower axially forward to cause a hammer to impact an output shaft.

10. The clutch mechanism as set forth in claim 9 wherein the ramp has a slope that increases toward the crest.

11. The clutch mechanism as set forth in claim 10 wherein the ramp extends generally along an arc having a constant radius of curvature.

12. The clutch mechanism as set forth in claim 11 wherein the radius of curvature of the ramp is about 8 millimeters.

13. The clutch mechanism as set forth in claim 9 wherein the raceway further comprises a descent portion extending from the crest on an opposite side of the crest from the ramp.

14. The clutch mechanism as set forth in claim 13 wherein the descent portion of the raceway has a slope that is different than the concaved slope of the raceway.

15. The clutch mechanism as set forth in claim 14 wherein the descent portion has a substantially constant slope.

16. The clutch mechanism as set forth in claim 9 further comprising a thrust ring connected to the hammer, said thrust ring being adapted for axial movement with the cam follower for axially moving the hammer into and out of contact with the anvil.
